(19) United States
(12) Patent Application Publication
(10) Pub. No.: US 2024/0283490 A1
(43) Pub. Date: Aug. 22, 2024

(54) RECONFIGURABLE REFLECTOR COMBINED WITH AMPLIFIER FOR WIRELESS COMMUNICATION AND OPERATING METHOD THEREOF

(71) Applicant: ELECTRONICS AND TELECOMMUNICATIONS RESEARCH INSTITUTE, Daejeon (KR)

(72) Inventors: Sang Rok MOON, Sejong-si (KR); Soo Yeon KIM, Daejeon (KR); Eon Sang KIM, Daejeon (KR); Min Kyu Sung, Seoul (KR); Seung Hyun CHO, Sejong-si (KR)

(21) Appl. No.: 18/582,486

(22) Filed: Feb. 20, 2024

(30) Foreign Application Priority Data
Feb. 22, 2023 (KR) 10-2023-0023543

(51) Int. Cl. H04B 7/04; H01Q 3/16

(52) U.S. Cl. CPC H04B 7/04013; H01Q 3/16

(57) ABSTRACT

According to an embodiment of the present disclosure, a reconfigurable reflector combined with an amplifier for wireless communication, comprising: an amplification module; a controller configured to control the reconfigurable reflector; and the reconfigurable reflector configured to reflect an output beam of the amplification module, wherein the amplification module includes, a first antenna configured to receive a beam and transmit the beam to an amplifier, an amplifier configured to amplify the input beam and transmit the amplified beam to a second antenna, and the second antenna configured to receive the amplified beam and transmit the amplified beam to the reconfigurable reflector, and an output of the second antenna is output to a predetermined position of the reconfigurable reflector.

### CROSS-REFERENCE TO RELATED APPLICATION

The present application claims priority to Patent Application No. 10-2023-0023543, filed on in Korea Intellectual Property Office on Feb. 22, 2023, the entire contents of which are incorporated herein by reference.

### TECHNICAL FIELD

The present disclosure relates to a reconfigurable reflector combined with an amplifier for wireless communication and an operation method thereof.

### BACKGROUND

The contents described below simply provide background information related to the present embodiment and do not constitute prior art.

Recently, as a transmission speed required for wireless communication systems has increased, a carrier frequency used for wireless communication has increased. There is an advantage in that higher transmission capacity can be provided as the carrier frequency increases. However, as the carrier frequency increases, transmission loss increases, and as straightness increases, there is a problem in that communication is blocked by obstacles. To solve this problem, a beam forming technology is emerging to minimize loss by bypassing and avoiding obstacles and concentrating a beam output at a desired point.

As one of these beamforming technologies, a reconfigurable intelligent surface, or more generally a reconfigurable reflector has been proposed.

FIG. 1 illustrates a beam forming system using a general reconfigurable reflector.

The beam forming system may include a transmitter 101, a receiver 102, a reconfigurable reflector 103, a controller 104, or the like.

The transmitter 101 transmits a beam, but does not transmit the beam directly to an obstacle, but transmits the beam to the reconfigurable reflector 103.

The reconfigurable reflector 103 receives the beam from the transmitter 101 and reflects the received beam to the receiver 102.

The receiver 102 receives a beam from the reconfigurable reflector 103.

The controller 104 supplies a control signal to the reconfigurable reflector 103 so that the beam reflected by the reconfigurable reflector 103 reaches the receiver 102.

There are several ways to configure the reconfigurable reflector 103, but the reconfigurable reflector 103 generally includes a set of small unit reflectors. Each unit reflector is configured to control a phase change amount that occurs when reflecting incident light. The controller 104 can control the direction and shape of the beam as desired by appropriately controlling the phase change amount of the unit reflector.

The beam forming system using a general reconfigurable reflector has the following three problems.

First, signals with a high carrier frequency have high transmission loss, and thus, it is necessary to compensate for additional transmission loss that occurs when a propagation path is bypassed through a reconfigurable reflector.

Second, when an area of incident light is not large enough, it is difficult to utilize all of the unit reflectors because only a portion of the reconfigurable reflector is covered, and control efficiency is reduced because only a limited number of unit reflectors are used.

Third, in order to know the phase change amount to be supplied by each unit reflector, it is necessary to check the distribution of which part of the reconfigurable reflector the beam incident from the outside enters. To achieve this, a separate algorithm is required to use a detector in the reconfigurable reflector or to control the reconfigurable reflector without knowing the distribution of the incident beam. However, using a separate algorithm increases the complexity of pricing and control.

### SUMMARY

The present disclosure provides a reconfigurable reflector combined with an amplifier for a wireless communication and an operation method thereof, which compensate for transmission loss of a beam with a high carrier frequency by amplifying the signal by an amplifier.

The present disclosure provides a reconfigurable reflector combined with an amplifier for wireless communication and an operation method thereof, which improve control efficiency/performance by utilizing the entire area of the reconfigurable reflector for the distribution of the beam received by the reconfigurable reflector.

The present disclosure provides a reconfigurable reflector combined with an amplifier for wireless communication and an operation method thereof, which eliminate the need for the reconfigurable reflector to detect an incident beam.

The problems to be solved by the present invention are not limited to the problems mentioned above, and other problems not mentioned can be clearly understood by those skilled in the art from the description below.

According to an embodiment of the present disclosure, a reconfigurable reflector combined with an amplifier for wireless communication, comprising: an amplification module; a controller configured to control the reconfigurable reflector; and the reconfigurable reflector configured to reflect an output beam of the amplification module, wherein the amplification module includes, a first antenna configured to receive a beam and transmit the beam to an amplifier, an amplifier configured to amplify the input beam and transmit the amplified beam to a second antenna, and the second antenna configured to receive the amplified beam and transmit the amplified beam to the reconfigurable reflector, and an output of the second antenna is output to a predetermined position of the reconfigurable reflector.

According to an embodiment of the present disclosure, an operation method for a reconfigurable reflector combined with an amplifier for wireless communication, the operation method comprising: transmitting a beam received from a first antenna to an amplifier; amplifying the beam input from the amplifier and transmitting the amplified beam to a second antenna; and transmitting the amplified beam from the second antenna to the reconfigurable reflector, wherein the amplification module includes the first antenna, the amplifier, and the second antenna, the reconfigurable reflector is controlled by a controller, the reconfigurable reflector reflects an output beam of the amplification module, and an output of the second antenna is output to a predetermined position of the reconfigurable reflector.

According to the present disclosure, it is possible to compensate for a transmission loss of a beam with a high carrier frequency by amplifying a signal by an amplifier.

According to the present disclosure, the distribution of beams received by the reconfigurable reflector can be kept constant by utilizing the entire area of the reconfigurable reflector, thereby improving control efficiency/performance.

According to the present disclosure, it is possible to solve the problem of increased cost and control complexity because the reconfigurable reflector does not need to detect the incident beam.

The effects of the present disclosure are not limited to the effects mentioned above, and other effects not mentioned may be clearly understood by those skilled in the art from the description below.

### BRIEF DESCRIPTION OF THE DRAWINGS

FIG. 1 illustrates a beam forming system using a general reconfigurable reflector.

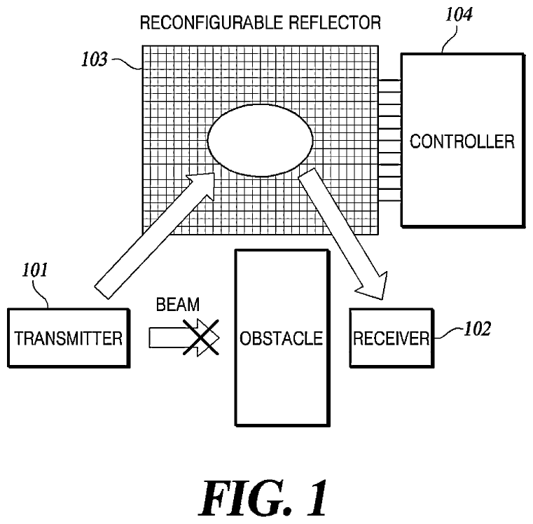

FIG. 2 is a structural diagram of a reconfigurable reflector combined with an amplifier for wireless communication according to one embodiment of the present disclosure.

FIG. 3 is an example diagram illustrating the operation of a reconfigurable reflector combined with an amplifier for wireless communication according to one embodiment of the present disclosure.

FIG. 4 is a relay system structural diagram for coverage expansion according to one embodiment of the present disclosure.

FIG. 5 is a first example diagram illustrating simulation results of the reconfigurable reflector combined with an amplifier for wireless communication according to one embodiment of the present disclosure.

FIG. 6 is a second example diagram illustrating the simulation results of the reconfigurable reflector combined with an amplifier for wireless communication according to one embodiment of the present disclosure.

FIG. 7 is a third example diagram illustrating the simulation results of a reconfigurable reflector combined with an amplifier for wireless communication according to one embodiment of the present disclosure.

FIG. 8 is a fourth example illustrating the simulation results of a reconfigurable reflector combined with an amplifier for wireless communication according to one embodiment of the present disclosure.

FIG. 9 is a fifth example diagram illustrating the simulation results of a reconfigurable reflector combined with an amplifier for wireless communication according to one embodiment of the present disclosure.

FIG. 10 is a sixth example illustrating the simulation results of a reconfigurable reflector combined with an amplifier for wireless communication according to one embodiment of the present disclosure.

FIG. 11 is an example diagram illustrating a process for expanding coverage according to one embodiment of the present disclosure.

FIG. 12 is a seventh example diagram illustrating the simulation results of the reconfigurable reflector combined with an amplifier for wireless communication according to one embodiment of the present disclosure.

FIG. 13 is an eighth example diagram illustrating the simulation results of the reconfigurable reflector combined with an amplifier for wireless communication according to one embodiment of the present disclosure.

FIG. 14 is an example diagram of a Digital Signal Processor (DSP) according to one embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

The following detailed description is intended to describe exemplary embodiments of the present invention and is not intended to represent the only embodiments in which the present invention may be practiced.

Hereinafter, in the present specification, a first antenna and an antenna 1 have the same meaning, so they will be used interchangeably. Additionally, in the present specification, a second antenna and an antenna 2 have the same meaning, so they will be used interchangeably.

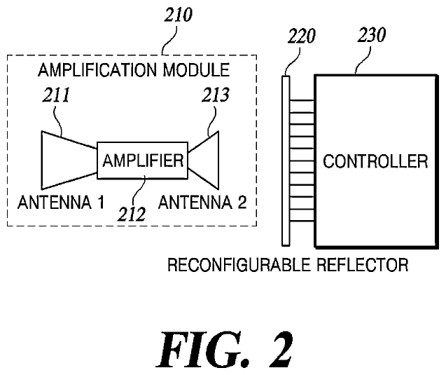

FIG. 2 is a structural diagram of a reconfigurable reflector combined with an amplifier for wireless communication according to one embodiment of the present disclosure.

The reconfigurable reflector combined with an amplifier for wireless communication according to the embodiment of the present disclosure may include an amplification module 210, a reconfigurable reflector 220, and a controller 230.

The amplification module 210 may be configured to include a first antenna 211, an amplifier 212, a second antenna 213, or the like. A THz relay, which will be described later, may include the first antenna 211, the amplifier 212, the second antenna 213, or the like. The THz relay can be configured between THz Access Points (APs). When the THz relay receives a signal from the THz AP, the received signal is transmitted to the reconfigurable reflector 220, and the reconfigurable reflector 220 reflects the received signal to a terminal (for example, UE (user equipment)).

The amplifier 212 has the same meaning as the THz amplifier, so they will be used interchangeably. Moreover, the relay has the same meaning as THz relay, so they will be used interchangeably.

The reconfigurable reflector combined with an amplifier for wireless communication structure according to the embodiment of the present disclosure has a structure in which the amplification module 210 including two antennas and one amplifier is added to the front of the existing reconfigurable reflector.

The amplification module 210 is fixed to the front of the reconfigurable reflector with, for example, a support (not illustrated in FIG. 2).

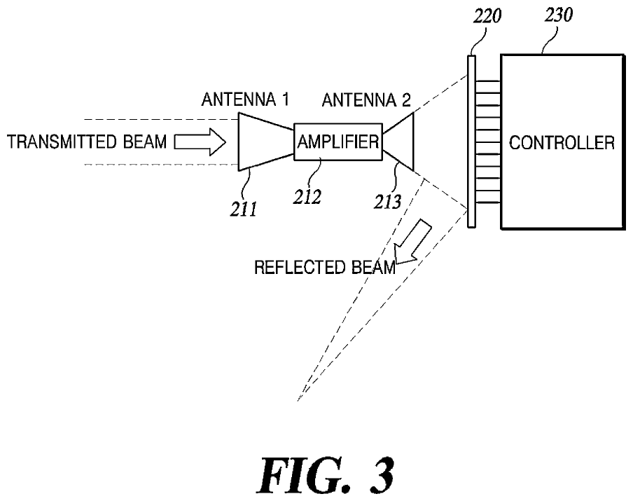

FIG. 3 is an example diagram illustrating an operation of the reconfigurable reflector combined with an amplifier for wireless communication according to one embodiment of the present disclosure.

The first antenna 211 may be configured to receive an external signal and transmit the external signal to the amplifier 212.

The amplifier 212 may be configured to amplify the signal input from the first antenna 211.

The second antenna 213 may be configured to transmit the signal amplified by the amplifier 212 to the reconfigurable reflector 230.

The output of the second antenna 213 may always be output to the reconfigurable reflector 230 in a fixed form. Therefore, since the beam incident on the reconfigurable reflector 230 is always incident on the predetermined position of the reconfigurable reflector, in the reconfigurable reflector combined with an amplifier for wireless communication according to the embodiment of the present disclosure, there is no need to determine the distribution of the beam incident on the reconfigurable reflector, so control and configuration may be simplified, and there is no need for a separate algorithm to control the reconfigurable reflector without knowing the distribution of the incident beam.

The beam distribution of the second antenna 213 may be adjusted to cover the entire area of the reconfigurable reflector 220, and the size and location of the second antenna 213 are calculated in advance and installed so that the reconfigurable reflector may operate optimally. Therefore, control efficiency/performance can be improved by utilizing the entire area of the reconfigurable reflector for the distribution of the beam received by the reconfigurable reflector.

The controller 230 may transmit a control signal for transmitting a beam to a receiver to the reconfigurable reflector 230 and control the direction and shape of the beam.

The reconfigurable reflector 230 may reflect the incident beam, and may be configured to reflect the beam to the receiver by providing a phase difference to the incident beam in accordance with a control signal received from the controller 230.

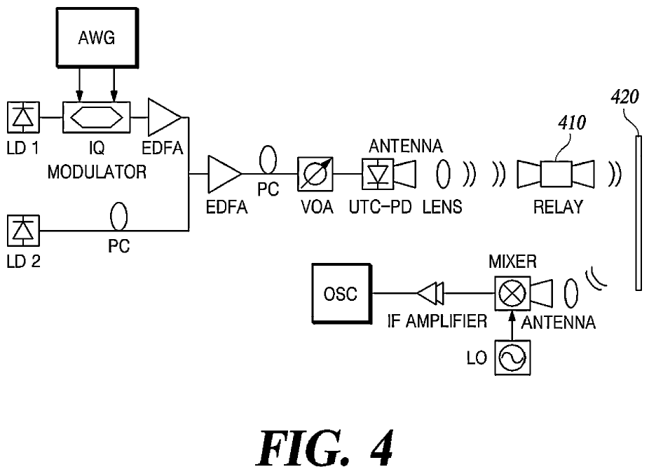

FIG. 4 is a relay system structural diagram for coverage expansion according to one embodiment of the present disclosure.

Referring to FIG. 4, the relay system may be configured to include a laser diode (LD) 1, an LD 2, an Arbitrary Waveform Generator (AWG), an IQ Modulator, a Polarization Controller (PC), an Erbium-Doped Fiber Amplifier (EDFA), a Variable Optical Attenuator (VOA), a Uni-Traveling Carrier-Photo Diode (UTC-PD), a lens, a relay, a mixer, an IF amplifier, an Oscilloscope (OSC), or the like.

To generate THz waveforms, photonics-based approaches may be utilized for high-speed signal modulation and transmission. The output of LD 1 is modulated by an IQ modulator with a bandwidth of 20 GHz. Data is generated by the AWG with a 120 GS/s sampling rate and 45 GHz bandwidth. Data-carrying light is mixed with the continuous waveform light output from LD 2 at the UTC-PD. Two PCs are used to control polarization.

At the front end of UTC-PD, the EDFA and VOA may be utilized to adjust THz Tx power as well as optical power.

To establish a wireless link, two antennas with a directional gain of 26 dBi and two lenses with a focal length of 10 cm may be used.

A THz relay 410 may be placed in the center of the wireless link, and the transmission distance is 1+1 m (for example, 1 m from THz Tx to the input of the relay and 1 m from the relay output to THz Rx). The relay 410 of FIG. 4 may utilize a THz amplifier using a horn antenna. The output signal of the relay 410 is transmitted to a reconfigurable reflector 420 according to the embodiment of the present disclosure, and the reconfigurable reflector 420 reflects the incident beam, as described in FIG. 2, and reflects the incident beam to a mixer by providing a phase difference according to the control signal received from the controller.

The wireless signal may be received by a mixer and down-converted to an intermediate frequency (IF) band. The central frequency of the IF signal is 20 GHz and may be determined by the frequency difference between the THz waveform and a local oscillator (LO). The IF signal can be re-amplified by an IF amplifier with a bandwidth of 55 GHz and captured by the OSC in real time at 80 GS/s and 36 GHz. The captured signal may be digitally processed to recover data. Since digital signal processing is unrelated to the present invention, detailed descriptions thereof will be omitted.

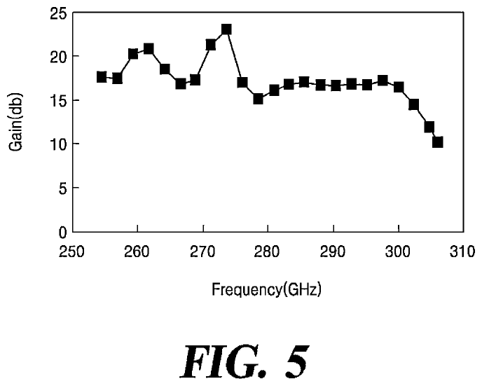

FIG. 5 is a first example diagram illustrating simulation results of the reconfigurable reflector combined with an amplifier for wireless communication according to one embodiment of the present disclosure.

FIG. 5 is an exemplary diagram illustrating the characteristics of the THz relay system, and in particular, illustrates gain characteristics of the THz amplifier used for the THz relay.

As illustrated in FIG. 5, a gain of 15 to 20 dB may be measured in a frequency range of 250 to 310 GHz. Since the THz amplifier has a flat response at 280 to 300 GHz, it can be selected as the carrier frequency after experimental optimization. It can be seen from FIG. 5 that the gain near 288 GHz is about 16 dB.

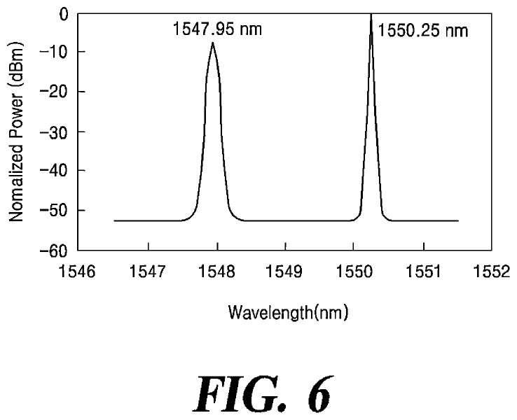

FIG. 6 is a second example diagram illustrating the simulation results of the reconfigurable reflector combined with an amplifier for wireless communication according to one embodiment of the present disclosure.

FIG. 6 is an example diagram illustrating the optical spectrum at the UTC-PD input, and in particular, the wavelength is, for example, 1547.95 nm and 1550.25 mn. It may be seen from FIG. 6 that an optical signal-to-noise ratio (OSNR) is higher than 50 dB. Therefore, the influence of optical noise can be ignored.

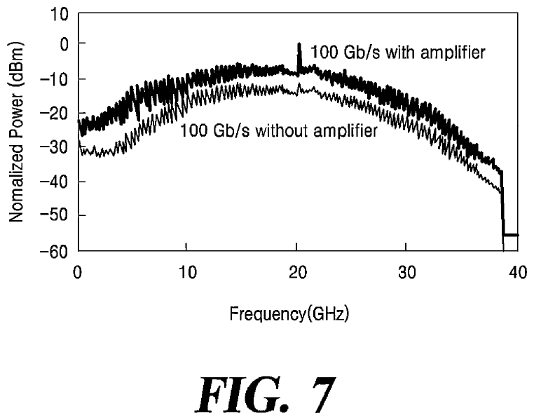

FIG. 7 is a third example diagram illustrating the simulation results of the reconfigurable reflector combined with an amplifier for wireless communication according to one embodiment of the present disclosure.

FIG. 7 illustrates the received spectrum of a 100 Gb/s 16 quadrature amplitude modulation (QAM) signal measured at the OSC. It can be seen from FIG. 7 that the distortion due to gain flatness is not severe. The gain by the THz relay may be measured at around 6 dB. The gain of about 6 dB may be 10 dB lower than the gain of the 16 dB THz amplifier in FIG. 5. Losses of the wireless link (for example, insertion loss and misalignment loss) may be included in link gain measurements.

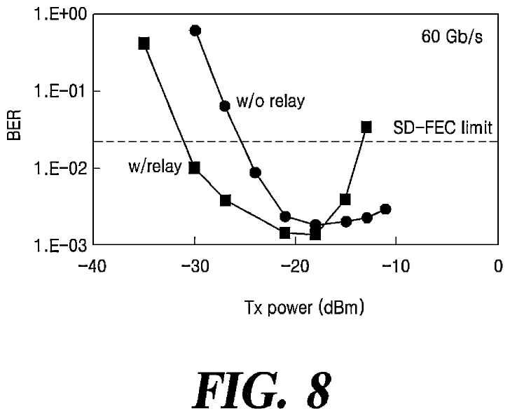

FIG. 8 is a fourth example diagram (in the case of 60 Gb/s) illustrating the simulation results of the reconfigurable reflector combined with an amplifier for wireless communication according to one embodiment of the present disclosure.

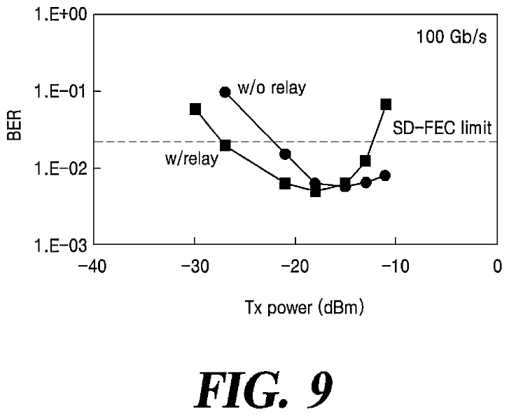

FIG. 9 is a fifth example diagram (in the case of 100 Gb/s) illustrating the simulation results of a reconfigurable reflector combined with an amplifier for wireless communication according to one embodiment of the present disclosure.

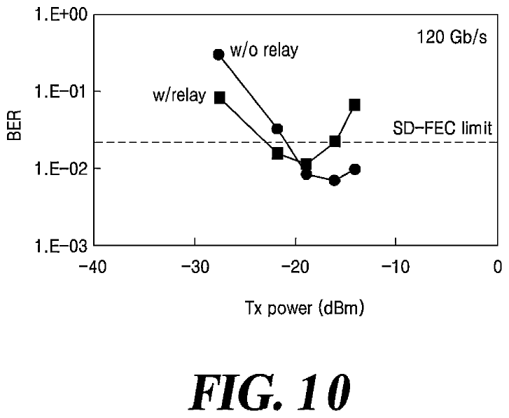

FIG. 10 is a sixth example diagram illustrating the simulation results (in the case of 120 Gb/s) of reconfigurable reflector combined with an amplifier for wireless communication according to one embodiment of the present disclosure.

FIGS. 8 to 10 illustrate Bit Error Rate (BER) curves as a function of Tx power without the THz relay and with the THz relay. In this case, it is assumed that the transmission distance is 1+1 m.

The BER measured at up to 120 Gb/s transmission may satisfy a soft decision forward error correction ((SD-FEC) threshold when the Tx power is appropriately adjusted (refer to FIG. 10). With the THz relay according to one embodiment of the present disclosure, a link gain of approximately 5 dB may be measured at 60 and 100 Gb/s (refer to FIGS. 8 and 9).

This value (5 dB) matches the measured gain illustrated in FIG. 7 with an additional 1 dB penalty.

The 5 dB link gain represents the potential for coverage expansion of 1.78 times.

Here, there are functions that need to be improved.

First, when the THz Tx power increases to a certain extent with the THz relay, the BER becomes worse, which limits the dynamic range of the THz Tx power. This phenomenon is due to power saturation of the THx amplifier. To increase the dynamic range of THz Tx power, the saturation power must be improved.

Second, at 120 Gb/s, the link gain decreases to about 2 dB. The cause of the decrease in the link gain is distortion caused by the uneven response of the THz amplifier. When the flatness of the THz amplifier is improved, the decrease in link gain can be improved.

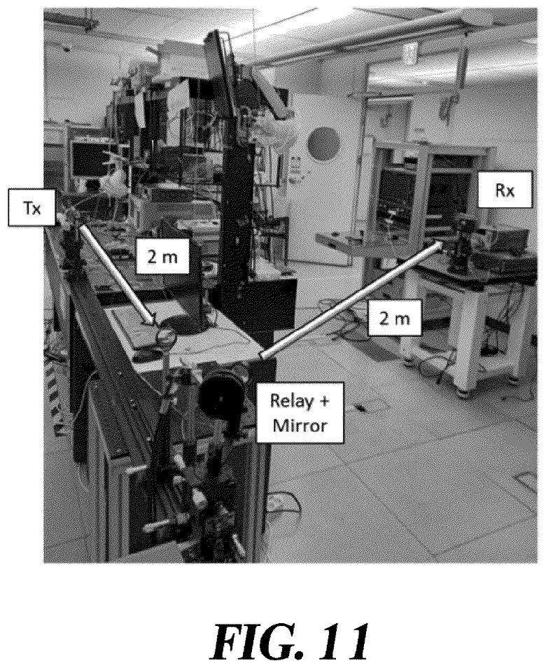

FIG. 11 is an example diagram illustrating a process for expanding coverage according to one embodiment of the present disclosure. FIG. 11 illustrates a photo of a demonstration setup.

The remaining components except the mirror in FIG. 11 are illustrated in FIG. 4.

Referring to FIG. 11, a reflection angle is approximately 40 degrees. The transmission distance is 2+2 m, and not only Non-Line of Sight (NLOS) transmission for blocking mitigation, but also 2× coverage expansion is implemented.

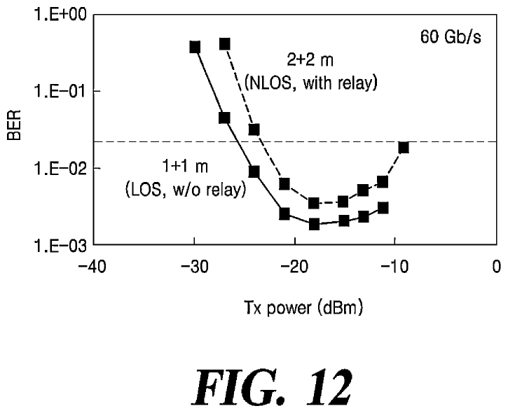

FIG. 12 is a seventh example diagram illustrating the simulation results of the reconfigurable reflector combined with an amplifier for wireless communication according to one embodiment of the present disclosure.

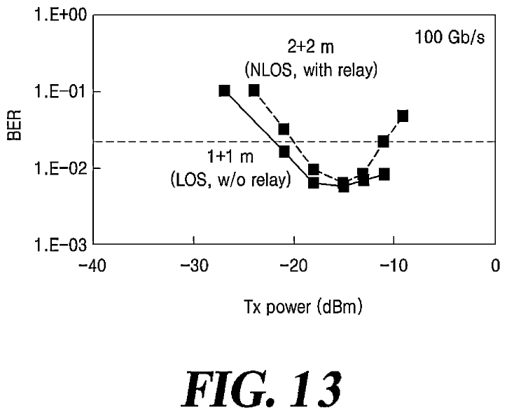

FIG. 13 is an eighth example illustrating the simulation results of the reconfigurable reflector combined with an amplifier for wireless communication according to one embodiment of the present disclosure.

FIG. 12 illustrates the transmission results for 60 Gb/s, and FIG. 13 illustrates the transmission results for 100 Gb/s.

FIGS. 12 and 13 illustrate that when the THz Tx power is in the dynamic range, the BER of 2+2 m NLOS transmission may satisfy the SD-FEC threshold.

Compared to the 1+1 m transmission result, the power penalty is about 1 dB. This can be expected at a 5 dB link gain and a 6 dB penalty due to twice the transmission distance.

The effect of the THz relay for a THz band indoor network according to the embodiment of the present disclosure may be confirmed through the measured link gain. The measured link gain is 5 dB (maximum 100 Gb/s), which can enable coverage expansion of about 1.78 times. The NLOS transmission and coverage expansion for blocking mitigation have also been implemented by combining mirrors (reconfigurable reflector 220 or RIS according to the embodiment of the present disclosure). In the present disclosure example, 2+2 m 100 Gb/s 16 QAM was successfully transmitted while satisfying the SD-FEC threshold. When the saturation power and flatness of the THz amplifier are improved, the transmission performance of the THz relay can be further improved.

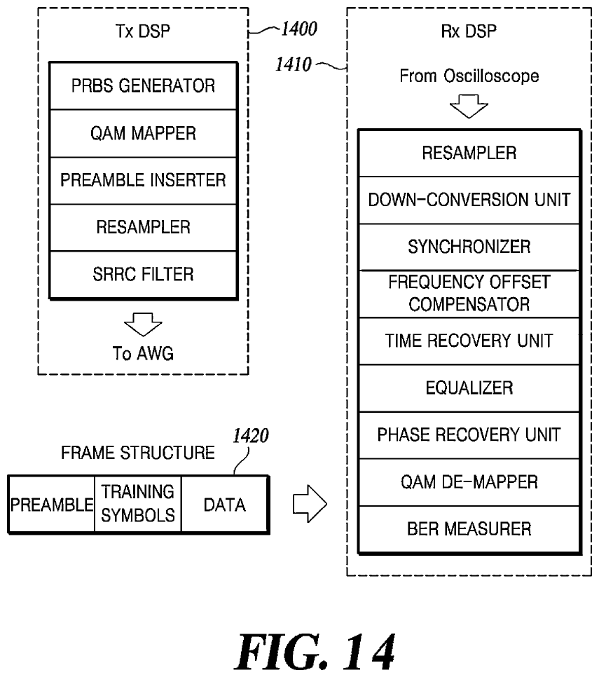

FIG. 14 is an example diagram of a DSP according to one embodiment of the present disclosure. That is, FIG. 14 illustrates a DSP structure diagram for off-line processing.

A Tx DSP 1400 may be configured to include a Pseudo Random Bit Stream (PRBS) generator, a quadrature amplitude modulation mapper (QAM mapper), a preamble inserter, a resampler, an SRRC (square root raised cosine) filter, or the like. The output of the SRRC filter is transmitted to the AWG in FIG. 4.

The Rx DSP 1410 may receive a signal from the OSC of FIG. 4 and may be configured to include a resampler, a down-conversion unit, a synchronizer, a frequency offset compensator, a time recovery unit, an equalizer, a phase recovery unit, a QAM de-mapper, a BER measurer, or the like.

The frame structure 1420 may be configured to include a preamble, training symbols, and data.

Since the Tx DSP 1400, the Rx DSP 1410, and the frame structure 1420 are unrelated to the operations of the relay 410 and the reconfigurable reflector 420 according to the embodiment of the present disclosure, detailed descriptions thereof will be omitted.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

### STATEMENT REGARDING PRIOR DISCLOSURES BY THE INVENTOR OR A JOINT INVENTOR

The inventors of the present application have made related disclosure in Sang-Rok Moon et al., “Demonstration of Coverage Extension and Blockage Mitigation with THz Relay for Indoor Network,” ECOC 2022, 2022. The related disclosure was made less than one year before the effective filing date (Feb. 22, 2023) of the present application and the inventors of the present application are the same as those of the related disclosure. Accordingly, the related disclosure is disqualified as prior art under 35 USC 102(a)(1) against the present application. See 35 USC 102(b)(1)(A).

What is claimed is:

1. A reconfigurable reflector combined with an amplifier for wireless communication, comprising:
an amplification module;
a controller configured to control the reconfigurable reflector; and
the reconfigurable reflector configured to reflect an output beam of the amplification module,
wherein the amplification module includes,
a first antenna configured to receive a beam and transmit the beam to an amplifier,
an amplifier configured to amplify the input beam and transmit the amplified beam to a second antenna, and
the second antenna configured to receive the amplified beam and transmit the amplified beam to the reconfigurable reflector, and
an output of the second antenna is output to a predetermined position of the reconfigurable reflector.

2. The reconfigurable reflector of claim 1, wherein a beam distribution of the second antenna is adjusted to cover the entire area of the reconfigurable reflector.

3. The reconfigurable reflector of claim 2, wherein a size and a location of the second antenna are predetermined to cover the entire area of the reconfigurable reflector.

4. The reconfigurable reflector of claim 3, wherein the amplification module is fixed by a support at the front of the reconfigurable reflector.

5. The reconfigurable reflector of claim 4, wherein the reconfigurable reflector gives a phase difference to the received beam according to a control signal received from the controller.

6. The reconfigurable reflector of claim 1, wherein an output of the reconfigurable reflector increases a non-line of sight (NLOS) transmission for blocking mitigation and expands coverage.

7. The reconfigurable reflector of claim 1, wherein the amplification module is disposed in a center of a wireless link.

8. The reconfigurable reflector of claim 1, wherein the amplification module includes a THz relay.

9. The reconfigurable reflector of claim 8, wherein when the THz relay is present, BER and Tx power measured from a 100 Gb/s 16 quadrature amplitude modulation (QAM) signal satisfies soft decision forward error correction (SD-FEC) threshold.

10. The reconfigurable reflector of claim 2, wherein the controller controls a direction and a shape of the beam.

11. An operation method for a reconfigurable reflector combined with an amplifier for wireless communication, the operation method comprising:
transmitting a beam received from a first antenna to an amplifier;
amplifying the beam input from the amplifier and transmitting the amplified beam to a second antenna; and
transmitting the amplified beam from the second antenna to the reconfigurable reflector,
wherein the amplification module includes the first antenna, the amplifier, and the second antenna,
the reconfigurable reflector is controlled by a controller,
the reconfigurable reflector reflects an output beam of the amplification module, and
an output of the second antenna is output to a predetermined position of the reconfigurable reflector.

12. The operation method of claim 11, wherein a beam distribution of the second antenna is adjusted to cover the entire area of the reconfigurable reflector.

13. The operation method of claim 12, wherein a size and a location of the second antenna are predetermined to cover the entire area of the reconfigurable reflector.

14. The operation method of claim 13, wherein the amplification module is fixed by a support at the front of the reconfigurable reflector.

15. The operation method of claim 14, wherein the reconfigurable reflector gives a phase difference to the received beam according to a control signal received from the controller.

16. The operation method of claim 11, wherein an output of the reconfigurable reflector increases a non-line of sight (NLOS) transmission for blocking mitigation and expands coverage.

17. The operation method of claim 11, wherein the amplification module is disposed in a center of a wireless link.

18. The operation method of claim 11, wherein the amplification module includes a THz relay.

19. The operation method of claim 18, wherein when the THz relay is present, BER and Tx power measured from a 100 Gb/s 16 quadrature amplitude modulation (QAM) signal satisfies soft decision forward error correction (SD-FEC) threshold.

20. The operation method of claim 11, wherein the controller controls a direction and a shape of the beam.
